(19) United States
(12) Patent Application Publication
(10) Pub. No.: US 2008/0109940 A1
(43) Pub. Date: May 15, 2008

(54) Display attachment for strap of wearing apparel or personal accessory

(76) Inventors: Ernest A. Van Den Heuvel, Park Ridge, NJ (US); Cliff Gardner, Double Oak, TX (US); Fred F. Ertl III, Peosta, IA (US); Michael Colson, Altoona, IA (US)

Correspondence Address: ALLAN L HARMS, 2750 FIRST AVENUE NE, SUITE 420, CEDAR RAPIDS, IA, 52402, US

(21) Appl. No.: 11/982,964

(22) Filed: Nov. 6, 2007

Related U.S. Application Data
(60) Provisional application No. 60/856,951, filed on Nov. 6, 2006.
(60) Provisional application No. 60/879,681, filed on Jan. 10, 2007.
(60) Provisional application No. 60/856,951, filed on Nov. 6, 2006.
(60) Provisional application No. 60/879,681, filed on Jan. 10, 2007.

(51) Int. Cl. A42B 1/00; A42B 1/24; A41D 27/08; G09F 3/00

(52) U.S. Cl. 2/209.12; 2/209.13; 2/244; 2/209.11; 40/329

(57) ABSTRACT

An attachment for an apparel strap such as a strap on a handbag, a backpack, a visor, a headband, or a size-adjustable baseball style sports cap which has a dome and adjustment strap or straps at the rear of the cap for adjustment of the size of the cap. The attachment has a badge member with a display surface and a rear surface on which a clasp member is fixed. The clasp member includes first and second elements which are separated by an elongate gap through which the adjustment strap may be maneuvered to place the strap between the clasp elements and the rear of the badge member so that the badge member is secured to the adjustment strap such that the display surface of the badge may be observed by a person in the presence of the wearer of the cap or other apparel.

### CROSS-REFERENCE TO RELATED APPLICATIONS

This application claims priority from co-pending provisional patent application Ser. No. 60/856,951 entitled “Display attachment for strap of wearing apparel or personal accessory”, filed Nov. 6, 2006; and from co-pending provisional patent application Ser. No. 60/879,681 entitled “Display attachment for strap of wearing apparel or personal accessory”, filed Jan. 10, 2007. The disclosures of both provisional patent application Ser. Nos. 60/856,951 and 60/879,681 are hereby incorporated in their entireties.

### FIELD OF INVENTION

This application relates to an attachment for a cap or other apparel items for displaying designs, photos, affiliation symbols, trademarks and logos, and in particular to an attachment that can be removably attached to a narrow strap on the cap or other apparel.

### BACKGROUND OF THE INVENTION

Casual baseball style sporting caps that are easily adjustable and useful for protecting the wearer's eyes from sunlight or rain are very popular. Such caps are generally made of fabric or woven material having a hemispherical crown or dome. Typically, inside the dome, at the lower periphery, is an adjustable strap or pair of straps for adjusting the circumference of the cap. An opening in the dome of the cap is typically provided above such adjustable strap. Most of such caps are decorated on the front portion of the dome with screen printed or embroidered indicia, such as team names, logos, trademarks, characters, designs, etc. It is sometimes convenient or fashionable to wear such caps backwards, with the visor directed rearwardly. Wearing the cap in this orientation deemphasizes the indicia displayed on the front portion of the dome of the cap.

The adjustment strap or straps located at the back of the cap are somewhat unattractive especially when the cap is worn backward. However, these adjustment straps can provide an attachment location for a badge or other signage to advertise the wearer's affiliation with a group, or support for individuals, causes, or organizations.

Prior attachments for the adjustment straps of baseball-style caps include those shown in U.S. Pat. Nos. 5,924,139 and 5,632,047 issued to co-inventor Van Den Heuvel. However the devices of these patents require attachment features which attach to the dome of the cap and do not provide a self-supporting attachment to the adjustment strap alone.

There are numerous other devices relating to means for displaying trademarks and logos on caps. Many of these devices are removable and have various means for attachment.

U.S. Pat. No. 2,796,680 to E. Wittcoff describes a hat adapted for various types of educational drills and games in which a series of problems or questions are imprinted along the outside face to the hatband and the correct answers can be ascertained from the inside face of the hatband though an aperture or window in the crown.

U.S. Pat. No. 4,333,180 to Bay describes a visor attached to a helmet by snaps.

U.S. Pat. No. 4,776,043 to Coleman describes a hat with interchangeable patches that can be selectively attached to the hat. An incomplete phrase or logo is printed on the front surface and a strip of fastening material or adhesive is secured to the hat just below the incomplete phrase. A plurality of separate patches is provided, each printed with a different word or phrase to complete the hat's printed phrase or logo, and each with a back surface that is attachable to the fastening material on the hat. Thus, the user can select the completion of the phrase with the patch of his choice.

U.S. Pat. No. 4,873,726 to Tapia describes an adjustable baseball type cap assemblage having a crown portion and various interchangeable visor portions. Insignia patches of various styles can be removably affixed to the selected visor and crown portions so that one cap assembly can be modified to identify with several athletic teams.

U.S. Pat. No. 4,985,935 to Hur describes a cap visor which includes a lower visor, a foldable upper visor, and a pop-up display located between the lower and foldable upper visor.

U.S. Pat. No. 5,003,640 to Pizzacar describes a cap having a removable advertising cap nameplate for concealing the pair of adjustable straps at the rear of the cap.

U.S. Pat. No. 5,253,368 to Blake describes a cap having a writing surface and a writing implement attached to the crown of the cap.

U.S. Pat. No. 5,282,278 to Miner describes a cap attachment which folds about and captures the rear straps of a baseball style cap. The attachment allows for the display of emblems or other indicia thereon.

U.S. Pat. No. 5,359,733 to Brannon et al. describes a hat which can simultaneously accept a plurality of patches. The patches are connected to the hat by hook and loop fasteners. The cap has an area of hook material either integrally formed with the cap or retrofitted to a pre-existing six-panel cap.

U.S. Pat. No. 5,359,734 to Rathburn describes a hat having an opening therein. One element of a hook-and-loop type fastening means is sewed in the opening. A number of cloth panels are provided, each of substantially the same size as the opening and bearing a name, logo, character, or other message on one side thereof. Each of the cloth panels has the other part of the two-part fastening means secured on its other side so that it may be attached to the hat when its particular name, logo, or other message has been selected for display with the hat.

U.S. Pat. No. 5,373,586 to Brosnan describes a sports cap and a replaceable pie-shaped panel made of one or more pie-shaped portions of fabric. The replaceable pie-shaped panel is detachably connected to the hat so as to be completely removable from the sports cap.

### BRIEF SUMMARY OF THE INVENTION

The present invention provides an attachment for a strap of a cap or other wearable garment or accessory. The attachment allows an apparel strap to be manipulated in between two clasps of the attachment. One surface of the attachment, which is opposite the clasps, allows for the display of a logo or other image. Therefore, when the invention is attached to an adjustment strap of a baseball type cap and the cap is placed on a person's head, the logo is displayed on the rear of the cap facing outward. The attachment does not require a secondary attachment connected to the dome of a cap as the attachment securely captures both sides of the apparel strap.

The invention includes a base plate having two surfaces. The first surface includes a clasp member including two clasp elements extending slightly from the first surface. The clasp elements are positioned in such a way that an elongated gap is formed between the free edges of the two clasp elements. The elongated gap between the free edges of the clasp elements may be serpentine or linear. The gap is substantially narrower than the width of a strap which is to be retained by the clasp. The strap is manipulated through the gap so that it is trapped inside a space defined by the two clasp elements and the wall of the base plate. Alternatively if the strap has a free end, it can be threaded through the space between the clasp elements and the rear surface of the base plate. Then the free end can be secured to the cap or other apparel item by the buckle or other capture element provided on the apparel. Once the strap has been manipulated through the clasp member, the second surface of the base plate is made available for viewing. The second surface of the base plate can be fitted with a logo, trademark, a greeting, photograph, motto, slogan, or some other statement the wearer desires to show to the public.

It is accordingly an object of this invention to provide an attachment which is easily removable from an apparel strap of a variety of clothing or accessories, especially a cap.

It is further an object of this invention to provide an attachment which is securely attached to an apparel strap without the use of a secondary fastener.

It is yet another object of the invention to provide an attachment with a display area such that a logo, mark, photograph, motto, or other information can be viewed on the display area of the attachment.

It is also an object of the invention to provide an attachment which covers the opening located on the rear of most caps with adjustment straps.

These and other objects of the invention will become apparent from examination of the description and claims which follow.

### BRIEF DESCRIPTION OF THE SEVERAL VIEWS OF THE DRAWING(S)

FIG. 1 is a perspective of a cap having the attachment invention fastened at the rear of the cap.

FIG. 2 is an exploded perspective view of the invention of FIG. 1.

FIG. 3 is a perspective of the rear of the attachment invention shown greatly enlarged.

FIG. 4 is a section view taken along line A-A of FIG. 3.

FIG. 5 is a front elevation of the preferred embodiment display attachment.

FIG. 6 is a rear elevation of the display attachment of FIG. 5.

FIG. 7 is a top plan view of the display attachment of FIG. 5, the bottom plan view thereof being identical.

FIG. 8 is a right side plan view of the display attachment of FIG. 5, the left side plan view thereof being identical.

FIG. 9 is a diagrammatic illustration of the shape of the base plate of the preferred embodiment of the invention as seen in FIG. 5.

FIG. 10 is a front perspective of the display surface of an alternative embodiment of the invention.

### DETAILED DESCRIPTION OF THE INVENTION

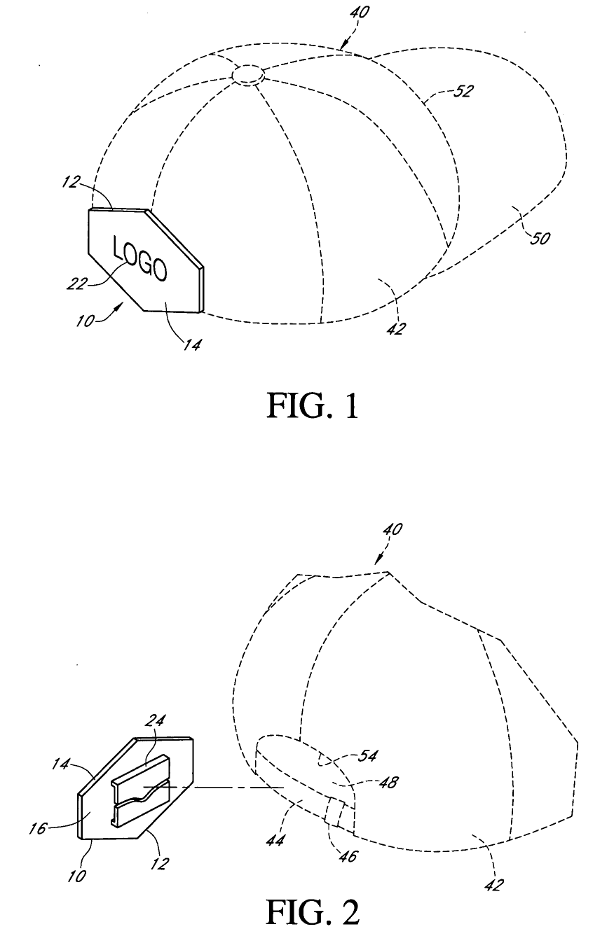

Referring to the figures, and in particular to FIGS. 1-4, an attachment 10 is preferably designed for application to a strap of an article of apparel such as a handbag, a backpack, a visor, a headband, or particularly, the adjustment strap 44 at the rear of a conventional cap 40. The cap 40 is a standard, adjustable, billed baseball-style cap made of fabric, plastic or other appropriate material. Cap 40 includes a brim or bill 50 which serves as a shade or a visor for the wearer, and also includes a dome 42 which covers the head of the user. The dome 42 includes a front wall portion or brow 52 and a rear opening 48 having at the bottom of the opening 48 an adjustment strap 44 which may be a pair of adjustable fastening straps or a single strap 44 engaged by a strap buckle or strap clasp 46. The opening 48 may be round, elliptical or some other selected shape. The border of the opening 48 is secured by a seam 54. The adjustable fastening strap 44 extends from the rear of the cap 40 to provide a means for adjusting the size of the cap 40.

The attachment 10 of this invention comprises a light weight base element 12 which has a first surface 14 and an opposing second surface 16. The base element 12 includes an information display 22 on the first surface 14. The information display 22 can be textual or graphic in nature, such as a trademark of a team, a business, a greeting, photograph, motto, slogan, or some other statement that the wearer of the cap 40 desires to show to the public.

Referring to FIG. 2, attached to the second surface 16 is a clasp member 24. This clasp member 24 is designed for removeably fastening the attachment 10 to strap 44 of the cap 40 or to any other item of apparel or personal accessory which includes a strap of width which may be received by clasp member 24.

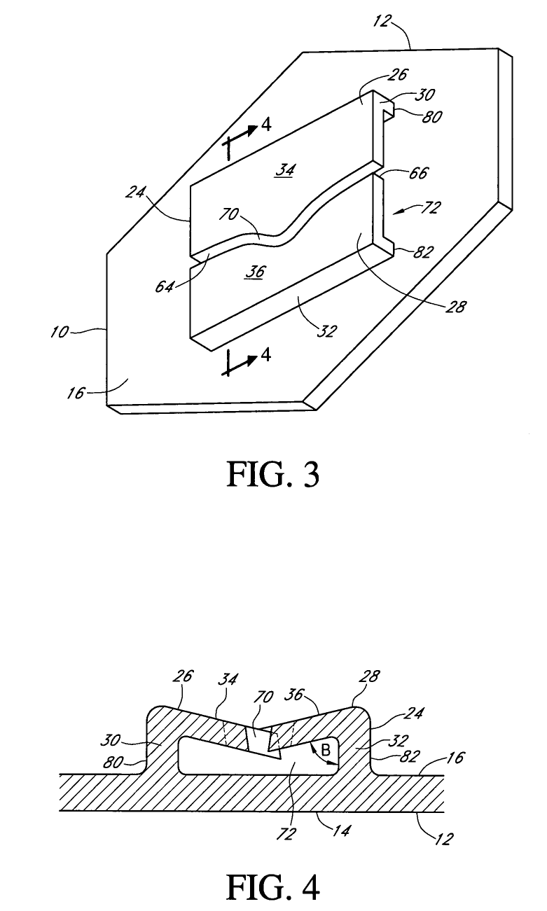

Referring to FIGS. 3 and 4, attachment 10 comprises a substantially planar base element 12 which may be of any shape including curvilinear or polygonal, though a hexagon is illustrated in the drawings. Base element 12 may be constructed of somewhat pliable polymers or other semi-rigid materials. Outlines of vehicles may be used for the outline of base element 12. Mounted to the second surface 16 of base element 12 is clasp member 24. Clasp member 24 comprises a first clasp element 26 and a second clasp element 28. Each clasp element 26 and 28 comprises a leg 30 and 32 extending generally perpendicularly from second surface 16 and attached thereto at a first end 80 and 82 respectively. Attached to legs 30 and 32 are trapping elements 34 and 36 which cantilever from legs 30 and 32. Trapping elements 34 and 36 have free edges 64 and 66 which define gap 70 between trapping elements 34 and 36. Gap 70 may be serpentine or linear and is generally of uniform width therealong. The free edges 64 and 66 follow each other at a substantially uniform spaced apart distance to constitute gap 70. Gap 70 is substantially narrower than the width of a strap to be manipulated therethrough.

Trapping elements 34 and 36 may be panels which overlie second surface 16. An enclosing space 72 is defined between trapping elements 34 and 36 and second surface 16, into which a strap such as strap 44 of cap 40 may be received to be retained by clasp member 24 to base element 12.

In FIG. 4, it can be seen that each of trapping elements 34 and 36 converges slightly toward second surface 16 as it extends from its connection to legs 30 and 32 respectively. It has been found that a suitable angle B between legs 30 and 32 and trapping elements 34 and 36 is preferably approximately seventy-five degrees, though trapping elements 34 and 36 may join legs 30 and 32 at as large an angle as a perpendicular. The strap of the cap or other item may be manipulated to pass it through the gap 70 so that the strap can enter space 72 and be oriented under trapping element 34 and 36.

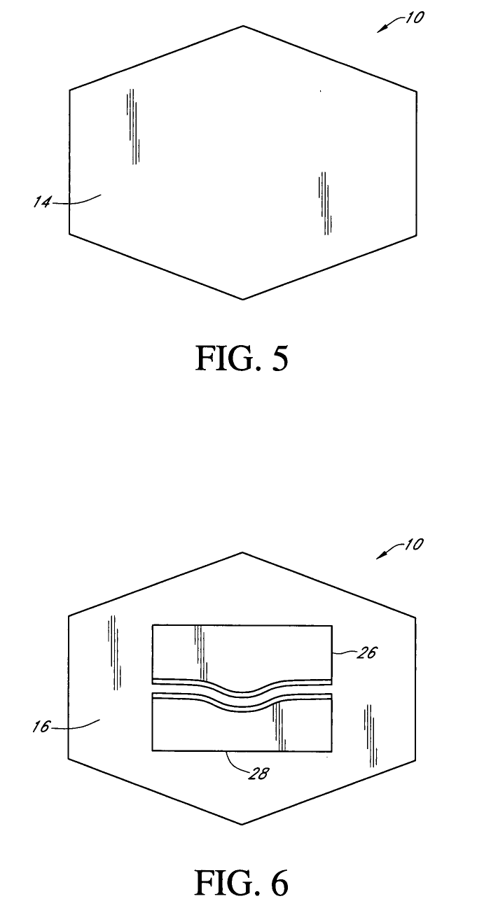

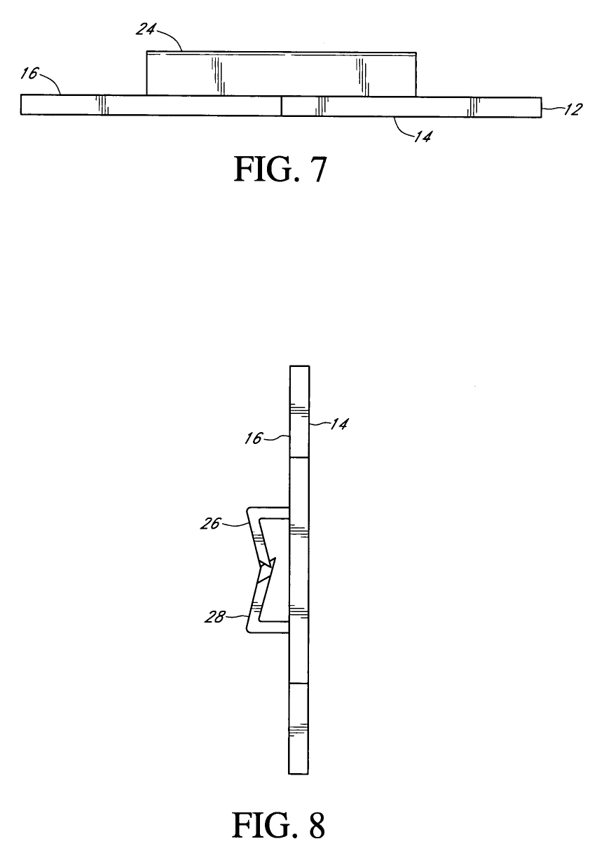

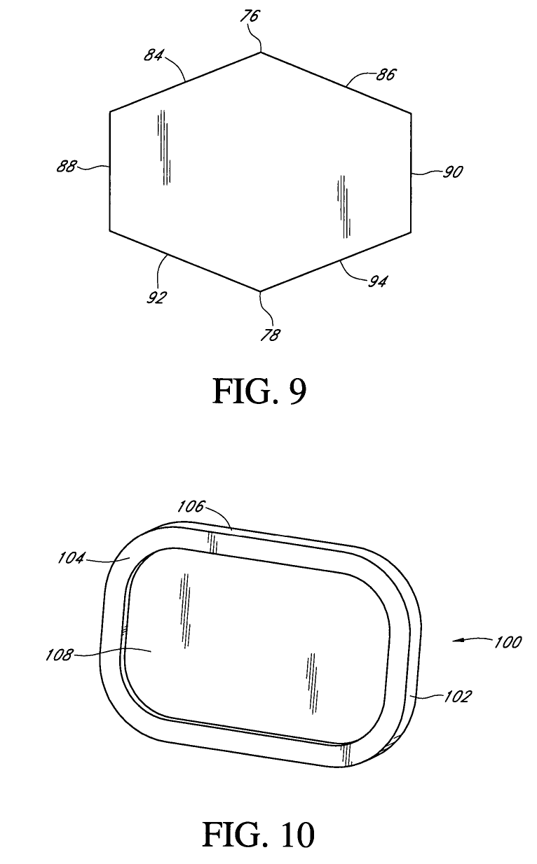

FIGS. 5-8 show elevation and plan views of the embodiment of the invention shown in FIGS. 1 through 4. FIG. 9 shows the geometric outline of the base element 12 of attachment 10.

The attachment 10 thus provides an information display 22 on the rear of the cap 40 such that information display 22 is securely attached to the cap 40 and may cover a portion or substantially all of the opening 48 in the dome 42. When the cap 40 is worn with bill 50 above the user's face, display 22 may be observed by persons positioned behind the user. When the cap 40 is worn with the bill 50 facing rearward, the information display 22 can be seen by people facing the person wearing the cap 40. If the attachment 10 is attached to a visor band or a headband, the attachment 10 may be attached along the strap thereof at various locations on the user's head.

FIG. 9 discloses a profile of the base element 12 of the attachment 10 of FIGS. 1 through 3. Base element 12 is preferably hexagonal in periphery, though the sides are not equal in length. Due to the orientation of a design, photo or textual material which may be displayed on information display 22 of base element 12 there will be a top 76 and bottom 78 of base element 12. The dimensions of base element 12 may be of any size appropriate for mounting to an adjusting strap 44 of a cap 40 (See FIG. 2) but in the preferred embodiment, the height is nominally fifty to fifty-five millimeters and the overall width is nominally sixty-five to seventy millimeters. Lower edges 92 and 94 of base element 12 join side edges 88 and 90 respectively at approximately sixty-five to seventy-five degrees while top edges 84 and 86 join side edges 88 and 90 respectively at a similar angle so that the base element 12 appears substantially symmetrical to the observer.

FIG. 10 discloses a front elevation of alternate embodiment 100 of the invention. The preferred periphery 106 of alternate embodiment 100 is a rounded rectangle reminiscent of a racetrack. The dimensions of alternate embodiment 100 may be of any size appropriate for mounting to an adjusting strap 44 of a cap 40 (See FIG. 2). The alternate embodiment 100 includes raised peripheral edge 104 upstanding from base element 102 on first surface 108 thereof. The preferred height of raised edge 104 above first surface 108 is approximately 0.5 to 3 millimeters. The preferred width of raised edge 104 may be approximately 1 to 3 millimeters.

Alternate embodiment 100 is provided with clasp elements on the rear thereof which are identical to the clasp elements 24 shown in FIGS. 3 and 4.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

Having described the invention, we claim:

1. An attachment for an apparel strap comprising
a base plate having a display surface and an opposing second surface,
the second surface including a clasp member attached thereto which may selectively received by the apparel strap,
the clasp member comprising a first clasp element and a second clasp element,
each of the first clasp element and the second clasp element including a first portion overlying a part of the second surface,
each clasp element including a free edge,
the free edge of the first clasp element opposing the free edge of the second clasp element.
the free edges defining an elongate gap therebetween,
whereby the apparel strap may be moved through the gap and captured between the first surface and the clasp member to retain the attachment to the apparel strap.

2. A combination cap and attachment for the cap comprising
a cap having a dome and at least one adjustment strap joined to a back of the cap for adjustment of the size of the cap,
an opening in the dome above the at least one adjustment strap,
an attachment removably attached to the at least one adjustment strap of the cap,
the attachment comprising:
a base plate having a first surface and an opposing second surface,
the first surface having a fastener fixed thereon,
the fastener comprising a first clasp element and a second clasp element, the second clasp element spaced a small distance from the first clasp element,
a gap separating the first clasp element and the second clasp element,
the first clasp element and the second clasp element defining a strap receiving space between the fastener and the first surface of the attachment.
the second surface including a display thereon.

3. The combination of claim 2 wherein
the first clasp element includes:
a leg element having a first end attached to the first surface,
an enclosing panel attached to a second end of the leg element and extending therefrom toward the second clasp element,
the second clasp element also including a leg element having a first end attached to the first surface and an enclosing panel attached to a second end of the leg element of the second clasp element, the enclosing panel of the second clasp element extending toward the first clasp element,
free edges of the enclosing panel of each of the first clasp element and the second clasp element defining a gap through which the at least one adjustment strap may be moved.
